(19) United States
(12) Patent Application Publication
(10) Pub. No.: US 2002/0137495 A1
(43) Pub. Date: Sep. 26, 2002

(54) Method for providing in services in a network, and associated network system

(76) Inventor: Mathias Gabrysch, Muenchen (DE)

Correspondence Address: BELL, BOYD & LLOYD, LLC, P. O. BOX 1135, CHICAGO, IL, 60690-1135, US

(21) Appl. No.: 10/086,227

(22) Filed: Feb. 27, 2002

(30) Foreign Application Priority Data
Feb. 27, 2001 (DE) 101 10 353.0

(51) Int. Cl. H04M 1/56; H04M 15/06

(52) U.S. Cl. 455/414; 379/215.01; 379/142.08

(57) ABSTRACT

A method for providing IN services in a network which use one or more network resources and can be triggered via suitable activated triggers in the network, the triggers being activated via an open network interface, and a network system having an intelligent network and at least one open network interface which can be used to activate triggers in the intelligent network which can trigger services which can be provided by the intelligent network.

### BACKGROUND OF THE INVENTION

Within the scope of the intelligent network (IN) concept, particular services in a network which go beyond the pure transmission service and complementary service features for this are concentrated in intelligent network nodes. Particularly services which need to be implemented and checked on a networkwide basis thus do not need to be provided per network node, but rather can be provided centrally over the entire network.

As such, new services can be introduced and used in the entire network easily and quickly. A prerequisite for providing an intelligent network is very high-performance exchange of information between the network nodes and a large, central database containing global network information which can be accessed quickly by any point in the network. The services are activated by particular service identification numbers or particular events. In this case, the service identification numbers do not address a switching center or terminating equipment in the network, but rather activate the service providers (servers) in the network; i.e., the identification number calls a particular service. The call number which may then occur is transferred to an IN computer which is connected to the network externally and evaluates the call number according to the service called. Only then is the setting information sent to the network and the two communication parties connected to one another. The information for ascertaining the current service destination is stored in the IN computer in databases for each service and service customer.

In today's telecommunications networks, the network operator is responsible for administration of operations on behalf of the network provider. Only the network operator has control over network resources and the associated functionalities. IN-based value added services generally require access to and control of network elements and network functions and, for this reason, are provided directly only by network operators themselves.

To use the Internet, private individuals and smaller companies generally need to have an agreement with an “Internet Service Provider” (ISP) which sets up access and an Internet address for them.

For them to be able to communicate over the Internet, the subscribers first need to contact the Internet access for their Internet Service Provider (ISP) at the next Point of Presence (POP); for example, in order to be able to view their e-mails or to write new ones. In this case, the connection to the provider is usually set up using a modem or an ISDN line.

The number of private Internet users using the telephone network to dial into the Internet is constantly growing. In this context, the majority of private servers continue to use an analog modem and usually occupy the only voice channel during the online session. The result of this is that the line is busy during the Internet session and no voice calls can be put through to the subscriber. This entails a number of drawbacks. First, it results in losses of income for the network operators, since telephone calls cannot be put through during an online session. In addition, it is disagreeable to the callers since they always hear the busy tone and cannot contact the called party during an online session, and the called party does not even know that they have called. It is also disagreeable to the Internet server or the called party to know that he/she is blocking his/her voice channel, which is usually the only one, during his/her online session. As such, the user no longer can be reached by telephone.

Thus, it is an object of the present invention to provide a simple method which allows a non-network operator, for example an Internet Service Provider (ISP), to provide intelligent services (IN services) himself/herself which use particular network resources and functionalities of the landline or mobile radio network.

Another object of the present invention is to provide a network system which allows a non-network operator, such as an Internet Service Provider, to provide his/her customers with IN services directly himself/herself

### SUMMARY OF THE INVENTION

Accordingly, the present invention provides a method for providing IN services in a network which use one or more network resources and can be triggered via suitable activated triggers in the network, the triggers being activated via an open network interface.

The present invention also provides a network system having an intelligent network and at least one open network interface which can be used to activate suitable triggers in the intelligent network which can trigger services which can be provided by the intelligent network.

Additional features and advantages of the present invention are described in, and will be apparent from, the following Detailed Description of the Invention.

### DETAILED DESCRIPTION OF THE INVENTION

IN hardware generally includes switching centers in the telephone network, so-called Service Switching Points (SSPs), which detect the actual call to an IN service and route it to an appropriate Service Control Point (SCP). The service itself runs in the SCP, a very high-performance computer with a large, complex database, which can process a large number of inquiries in a short time. The SSP is a digital switching center containing special control programs. The call to an IN service is coupled to an appropriately predefined trigger in the switching center's control.

The IN elements essentially influence control of the connections. The control operations by the IN system cause the user channels to be connected within the telecommunications network.

When an appropriate event occurs, trigger points, so-called detection points, are passed which can trigger an action.

At these trigger points, the IN services can start. In this case, the signaling can be routed to the SCP or a connection can be monitored or controlled. The SCP controller can, in turn, “sharpen” a particular detection point. Using the inventive method, it is now possible to activate such a trigger via an open network interface. As such, it is also possible for a non-network provider to “sharpen” a trigger point or a “detection point” via this open network interface.

Preferably, the open network interface is an API (Application Programming Interface) defined by the Parlay Group, referred to below as Parlay API, or an OSA API. Whereas the Parlay API is predominantly used in the landline network sector, the OSA API is preferably used in the mobile radio network. The introduction of open network interfaces, such as the Parlay API or the OSA API, will also allow non-network users to provide intelligent services which use particular network resources and functionalities of the landline or mobile radio network. In this context, the open network interface can be used to activate particular triggers, so-called Trigger Detection Points (TDPs), in the landline network SSP.

In one preferred embodiment of the inventive method, an Internet Call Waiting service (ICW) is provided. The inventive method allows Internet Service Providers to provide their customers with the Internet Call Waiting service (ICW) in addition to the Internet access service. As such, during the online session, in the event of a call, servers can decide in real time whether they wish to take the call, reject it or redirect it. In this case, the main advantage to the customer is that he/she also can be reached by telephone during the online session. A great advantage to the Internet Service Provider (ISP) is that providing an ICW service gives him/her a competitive advantage over other Internet Service Providers. This is very important, particularly in times of increased competitive pressure, since it allows him/her to distinguish himself/herself from competitors. In addition, the inventive method also entails advantages to the network operator. First, he/she is provided with increased income as a result of payment for use of the open network interface; for example, the Parlay API or the OSA API. He/she also has no or few losses as a result of telephone calls which are not put through. Furthermore, the users of the telephone network are more satisfied, since they no longer encounter busy lines as frequently.

Referring now to the network system of the present invention, the associated open network interface preferably is again a Parlay API or an OSA API.

In one particularly preferred embodiment of the inventive network, the open network interface can be used to activate an Internet Call Waiting service. Preferably, the services which can be provided by the intelligent network are activated by an Internet Service Provider. Upon activation of the service of the Parlay-based ICW service, the server has subscribed to the ICW service with his/her Internet Service Provider; i.e., the server has submitted to his/her Internet Service Provider that he/she wishes to make use of the ICW service. The server or user dials up his/her Internet Service Provider from home in the normal way. The user profile held with the Internet Service Provider contains not only user-specific data, such as the name of the user, the user's password and the user's address, but also an entry about subscription to the ICW service. The result of this is that the application, or the ICW service, is started in a computer, referred to below as the client. The client, which is located with the Internet Service Provider, uses the open network interface (i.e., preferably uses a Parlay API or an OSA API), to activate the appropriate triggers in the telecommunications network on an appropriate gateway which is located with the network operator. A state has now been reached in which another call to the user or server puts the ICW service into use.

If another subscriber in the network now attempts to call the server or the Internet user during his/her online session, an enquiry is started on the gateway to determine how to handle the call attempt, since the trigger has been activated in the service switching point (SSP) responsible for the Internet server in the network. The gateway informs the Internet Service Provider's client about the occurrence of this event. The actual Internet Call Waiting application (ICW) is then started on the client. At the end of the program, a particular selectable action is initiated. The client uses the Parlay API or the OSA API to inform the gateway about the action to be performed. The gateway, in turn, instructs the SSP to perform the action. In this case, actions which can be selected differently can be offered. By way of example, the Internet service user's Internet session could be terminated and the call put through. An announcement also could be played for the caller. Furthermore, the caller could be transferred to another call number, be it a call number in the landline network or in the mobile network. It is also conceivable for the call to be forwarded to a “Voice over IP Media Gateway”. The Voice over IP Media Gateway would allow the surfer to speak to the caller on the telephone, for example using a headphone/microphone set connected to his/her computer, without interrupting the “online session”. This gateway could be located with the Internet Service Provider.

The service user himself/herself can conveniently use a web-based GUI (Graphical User Interface) to stipulate in his/her service profile which of the aforementioned actions is initiated. By way of example, he/she can set a preconfigured announcement to be played to the caller on the basis of the time of day and the CLI.

Preferably, the server or the user himself/herself interactively makes the decision regarding what is to happen. To this end, on dialing up the Internet Service Provider, the server has automatically started a program in the background which is then activated by the ICW application via the IP link. The server or user has a window which notifies the server that somebody is attempting to call the user. The server can now interactively click on one of the selectable actions. The response is then transmitted, again via the active IP link, to the ICW application, which then uses the Parlay API or the OSA API to implement the instruction on the gateway.

Although the present invention has been described with reference to specific embodiments, those of skill in the art will recognize that changes may be made thereto without departing from the spirit and scope of the invention as set forth in the hereafter appended claims.

1. A method for providing IN services in a network which uses at least one network resource, the method comprising the steps of:
triggering the services via suitable activated triggers in the network; and
activating the triggers via an open network interface.

2. A method for providing IN services in a network as claimed in claim 1, wherein the open network interface is a Parlay API.

3. A method for providing IN services in a network as claimed in claim 1, wherein the open network interface is an OSA API.

4. A method for providing IN services in a network as claimed in claim 1, wherein an Internet Call Waiting service is provided as one of the IN services.

5. A network system, comprising:
an intelligent network; and
at least one open network interface for activating suitable triggers in the intelligent network which can trigger services provided by the intelligent network.

6. A network system as claimed in claim 5, wherein the open network interface is a Parlay API.

7. A network system as claimed in claim 5, wherein the open network interface is an OSA API.

8. A network system as claimed in claim 5, wherein an Internet Call Waiting Service is one of the services.

9. A network system as claimed in claim 5, further comprising a control unit associated with an Internet service provider, wherein the control unit can activate the switchable triggers.
